(19) United States
(12) Patent Application Publication
(10) Pub. No.: US 2016/0339846 A1
(43) Pub. Date: Nov. 24, 2016

(54) INTEGRATED CARGO COVER

(71) Applicant: FORD GLOBAL TECHNOLOGIES, LLC, Dearborn, MI (US)

(72) Inventor: Diego Fabricio Villacres Mesias, Toluca (MX)

(21) Appl. No.: 14/714,486

(22) Filed: May 18, 2015

(51) Int. Cl. B60R 5/04

(52) U.S. Cl. CPC B60R 5/047

(57) ABSTRACT

A cargo cover assembly for a vehicle seat split seatback includes a plurality of retractors and a flexible panel configured to deploy from and retract into each retractor. At least one support rod is associated with each flexible panel, configured for releasably coupling inboard ends of adjacent aligned support rods to define a substantially transverse flexible panel support rib.

### TECHNICAL FIELD

This disclosure relates generally to cargo covers. More particularly, the disclosure relates to a cargo cover integrated to a second or third-row seatback.

### BACKGROUND

It is known to provide deployable coverings for cargo areas in vehicles, for example for the cargo areas of sport-utility vehicles (SUVs), hatchbacks, etc. Such cargo covers provide utility in hiding items held in the vehicle cargo area from view, reducing the likelihood of theft. Additionally, cargo covers serve to protect items held in the cargo area from, e.g., direct sunlight.

Conventional cargo covers are typically provided as a separate roll shade type covering associated with a deploying/retracting mechanism, attached to the rear of a vehicle second or third seat row seatback. The cargo cover and deploying/retracting mechanism must be at least substantially the width of the vehicle cargo area, and must follow the vehicle quarter panel contours and liftgate trim to prevent exposure of items held in the cargo area. The mechanism for deploying/retracting the cargo cover is typically similar to that used in retractable seat belts or roll-type shades, and does not require extensive description herein. To deploy, the user need only grasp the end of the cover, or a handle associated with the end, and pull. A detent mechanism may be provided to prevent the cover from inadvertently retracting until the user so desires. Alternatively or additionally, a hook or other retainer may be provided in the vehicle cargo area to hold the cover in a desired deployed orientation.

Such conventional cargo covers are suitable and effective for their intended purpose, but suffer from certain disadvantages. Because the cover and deploying/retracting mechanism are provided as a unit for attachment to a seatback rear, they impinge on the available storage space in the vehicle cargo area. As a result, the vehicle user may have to remove the unit to store larger items or greater numbers of items, for example items or groups of items that exceed the seatback height.

In turn, many vehicle second and third-seat rows include split seatbacks, for example 60:40 or 50:50 split seatbacks. Split seatbacks provide convenience because the user is able to fold a portion of the seatback forward to increase available cargo storage space while still providing passenger seating in the second or third seat row. However, when only a portion of the seatback is folded forward, the conventional roll-type cargo cover spanning the width of the seatback cannot be used and must be removed.

These inconveniences may cause users to forgo the advantages of a cargo cover and simply remove the cargo cover mechanism rather than continually having to remove/reinstall it. To solve these and other problems, the present disclosure relates to a cargo cover for a vehicle that is integral to a vehicle seatback, for example a seatback of a vehicle second or third seat row. The described cargo cover mechanism is further advantageously adapted for use with a split seatback. Conveniently, the described cargo cover mechanism does not impinge on available cargo storage space, and need not be removed to accommodate larger/greater numbers of items in the vehicle cargo area.

### SUMMARY

In accordance with the purposes and benefits described herein, in one aspect a divided cargo cover assembly is described including a plurality of retractors and a flexible panel configured to deploy from and retract into each retractor. In an embodiment, the retractors include a rotary reel mechanism for deploying and retracting the flexible panels. At least one support rod is associated with each flexible panel, typically disposed in an orientation substantially transverse to a longitudinal dimension of the panel. The support rods are configured for releasable coupling, such as by fitting with releasable fasteners for coupling the ends of adjacent aligned support rod one to another to define a substantially transverse flexible panel support rib spanning substantially the width of the flexible panels. As will be appreciated, this allows defining a cargo cover providing full coverage of the vehicle cargo area, even when multiple retractors/flexible panels associated with a vehicle split seatback are provided.

The retractor/flexible panel mechanisms are configured to be disposed in an interior of a vehicle seatback, usually attached to a portion of the seatback frame. In embodiments, each seatback portion of a vehicle split seatback will be provided a retractor/flexible panel mechanism having a width substantially corresponding to that seatback portion width. So, a split seatback having two portions (for example, a 60:40 split or a 50:50 split) may be provided with two correspondingly dimensioned retractor/flexible panel mechanisms. A split seatback having three portions may be provided with three correspondingly dimensioned retractor/flexible panel mechanisms, and so on. A retainer may be provided at a distal end of the vehicle cargo area for holding each flexible panel in a deployed configuration. Optionally, guide slots may be included in association with the cargo area side walls (i.e., along an interior of the vehicle rear quarter panels) to guide and hold the exterior edges of the flexible panels. As will be appreciated, this feature allows providing a cargo cover adapted to a split seatback design, which provides full coverage of a vehicle cargo area but which does not occupy usable cargo area storage space.

In other aspects, vehicle seats and vehicles including the above-summarized cargo cover assembly are described.

In the following description, there are shown and described embodiments of the disclosed cargo cover assembly. As it should be realized, the device is capable of other, different embodiments and its several details are capable of modification in various, obvious aspects all without departing from the devices and methods as set forth and described in the following claims. Accordingly, the drawings and descriptions should be regarded as illustrative in nature and not as restrictive.

### BRIEF DESCRIPTION OF THE DRAWINGS

The accompanying drawing figures incorporated herein and forming a part of the specification, illustrate several aspects of the disclosed warning indicator, and together with the description serve to explain certain principles thereof. In the drawing:

FIG. 1 depicts a prior art cargo cover for a vehicle cargo area;

FIG. 2 is a side view of a cargo cover according to the present disclosure;

FIG. 3 is a rear perspective view of a deployed cargo cover for a split seatback according to the present disclosure;

FIG. 4 shows the cargo cover of FIG. 3, with the vehicle seat seatbacks folded forward; and

FIG. 5 shows the cargo cover of FIG. 4 with the cargo cover panels deployed.

Reference will now be made in detail to embodiments of the disclosed vehicle cargo cover, examples of which are illustrated in the accompanying drawing figures.

### DETAILED DESCRIPTION

The presently disclosed divided cargo cover assembly is discussed herein in the context of a vehicle split seat/seatback, in the depicted embodiments being a 60:40 split seat. However, it will readily be appreciated that the disclosed cargo cover is easily adaptable to other structures such a 50:50 split seatback, a three way split seatback, etc., simply by altering the dimensions of the cargo cover assemblies that will be described in detail below. Accordingly, the disclosure will not be taken as limiting.

Also, various retractor mechanisms as discussed herein are well-known in the art, for example the deploying/retracting mechanisms used in, e.g., retractable vehicle seat belts, roll-type shades, etc. At a high level, such mechanisms include one or more of a rotary reel configured for deploying/retracting a flexible panel or web, a detent mechanism for preventing unwanted retraction of the panel once deployed, and a release mechanism to allow deployment/retraction of the panel. The skilled artisan is very familiar with such mechanisms, and so they will not be extensively described herein.

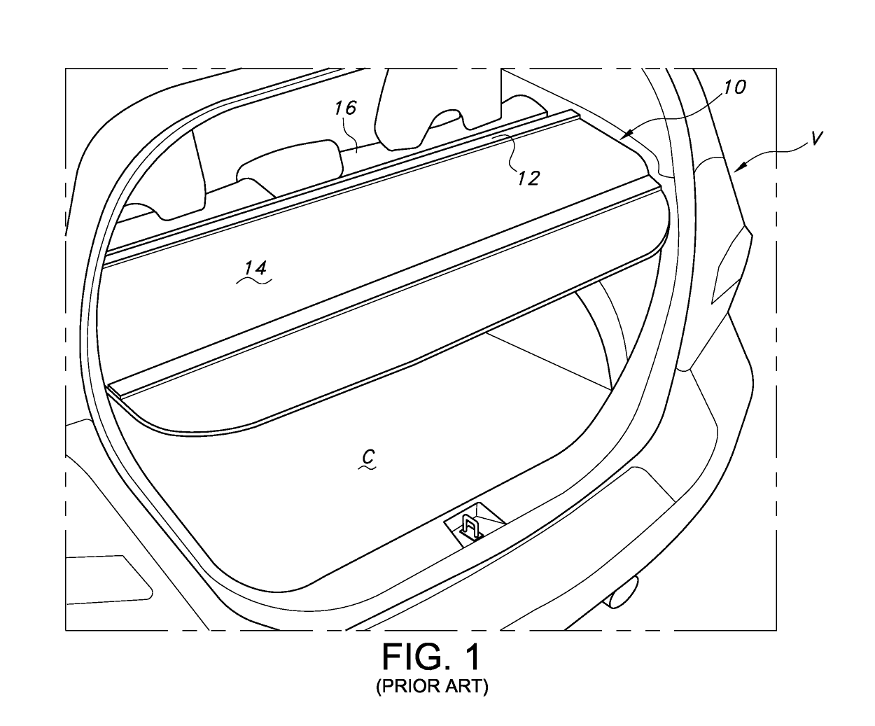

Turning now to FIG. 1, a vehicle V is depicted including a cargo area C. A prior art cargo cover assembly 10 is shown partially covering cargo area C. The cargo cover assembly 10 includes a retractor mechanism 12 configured for deploying and retracting a flexible panel 14 which covers some or all of cargo area C. As shown, retractor mechanism 12 is attached to a vehicle seat seatback 16, and so impinges on available storage space of cargo area C.

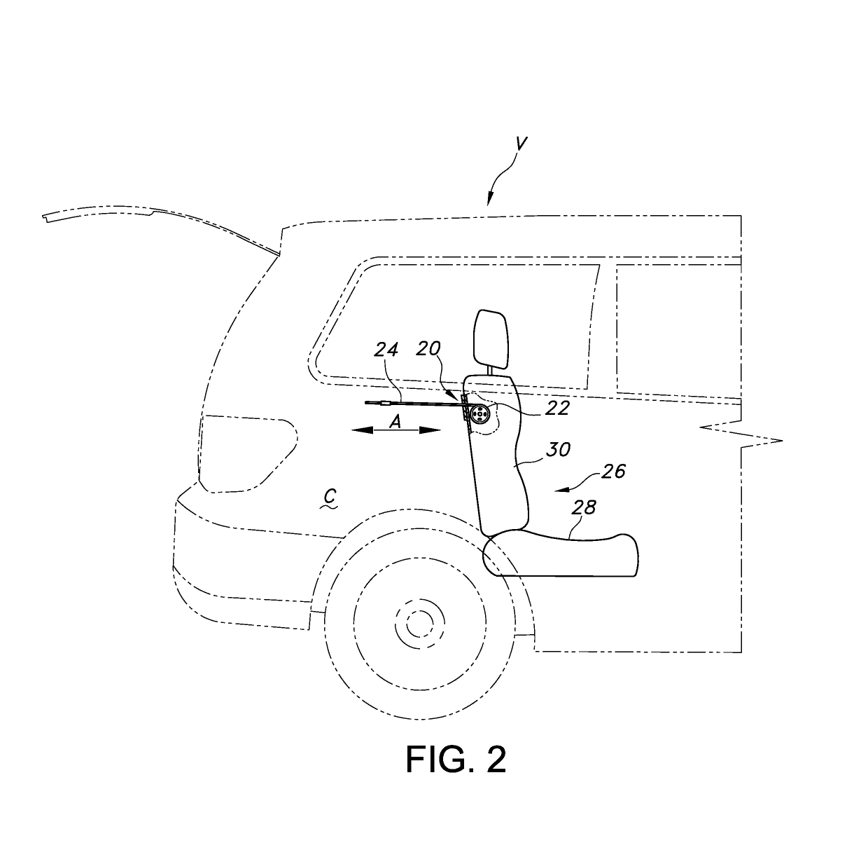

With reference to FIG. 2, a cargo cover assembly 20 according to the present disclosure is shown. As depicted, the cargo cover assembly 20 includes a retractor mechanism 22 (in the depicted embodiment being a spring-driven rotary reel retractor mechanism known in the art) and a flexible panel 24. Vehicle V includes a seat 26 defined by a bottom 28 and a seatback 30. As shown, retractor mechanism 22 is disposed within an interior of seatback 30, and is secured to a frame (not shown) of seatback 30. Thus, a portion of flexible panel 24 is deployed from and retracted into (see arrow A) an interior of seatback 30 by retractor mechanism 22.

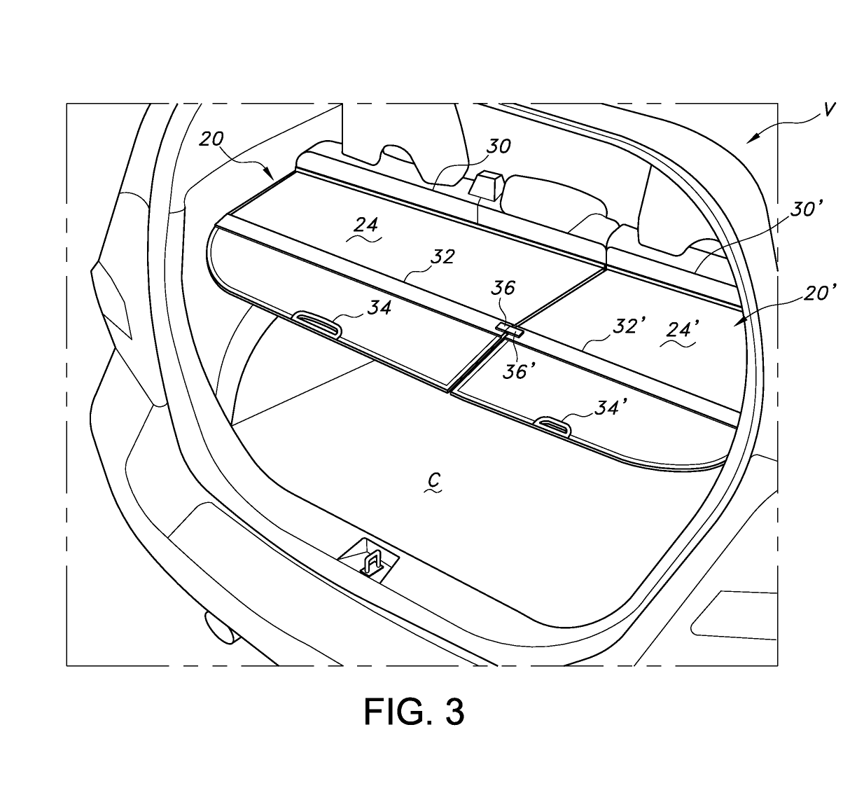

Turning to FIG. 3, it is contemplated to provide a divided cargo cover assembly 20, 20′ associated with a split seatback 30, 30′. A pair of substantially collinearly aligned retractor mechanisms 22, 22′ (not visible in this view) and flexible panels 24, 24′ are included. Each flexible panel 24, 24′ may include at least one support rod 32, 32′ for providing lateral/transverse support to a distal portion of each flexible panel 24, 24′. Handles 34, 34′ may be included at a distal end of each flexible panel 24, 24′ to improve user convenience in deploying the flexible panels.

The support rods 32, 32′ are configured for releasable coupling. In the depicted embodiment, cooperating releasable fastener structures 36, 36′ are included at the inboard ends of adjacently aligned support rods 32, 32′, for coupling those inboard ends to provide a substantially transverse or lateral support to both flexible panels 24, 24′. As will be appreciated and as is shown in the drawing figure, this allows providing full coverage of cargo area C using paired deployed flexible panels 24, 24′, without significant gaps created by sagging or otherwise misaligned portions of the flexible panels. On the other hand, if coverage of only a portion of cargo area C is desired, a user need only deploy one or the other of flexible panels 24, 24′without coupling support rods 32, 32′. While as depicted each flexible panel includes a single support rod, of course the skilled artisan will appreciate that additional support rods could be provided as necessary according to user preference, as necessary according to the dimensions/weight of the flexible panels 24, 24′, etc. Also, any number of suitable fastener mechanism types as are known in the art could be adapted for use as releasable fastener structures 36, 36′, including without intending any limitation magnetic fasteners, snap fit fasteners, friction fit fasteners, interference fit fasteners, latching fasteners, hook fasteners, and combinations thereof.

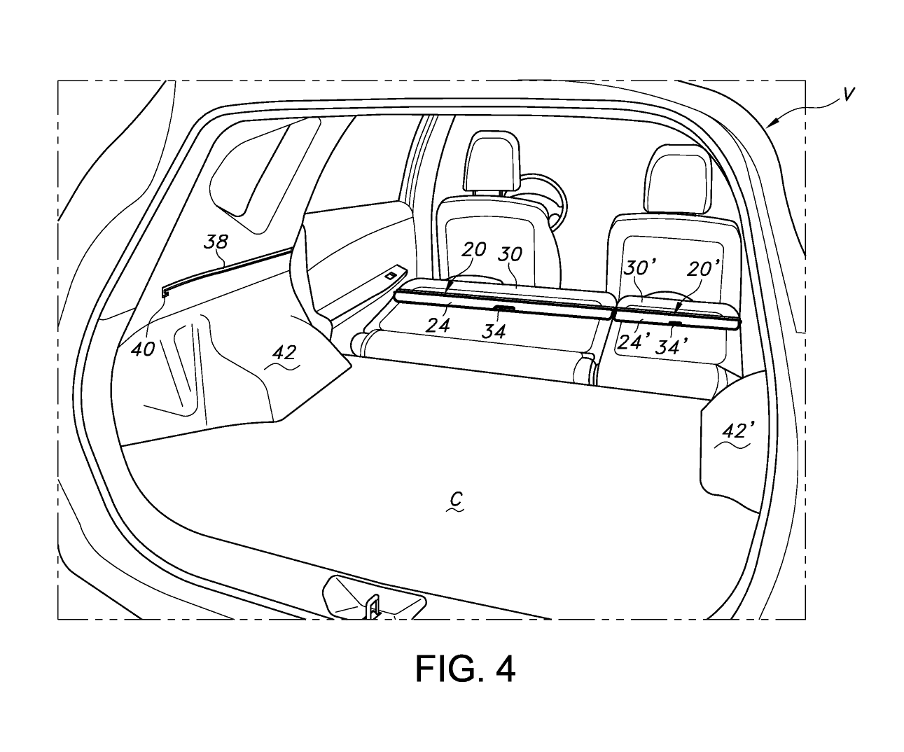

Turning to FIG. 4, wherein vehicle V seatbacks 30, 30′ are depicted in a folded forward configuration, guides 38, 38′ (opposed slot 38′ not visible in this view) may be provided for receiving and guiding an outboard edge of flexible panels 24, 24′. Retainers 40, 40′ (retainer 40′ not visible in this view) may be included to retain or assist in retaining flexible panels 24, 24′ in the deployed configuration. Guides 38, 38′ may be defined by any suitable structure, such as by slots defined in opposed side walls 42, 42′ of cargo area C, by guide rails attached to side walls 42, 42′ of cargo area C, and others. In turn, retainers 40, 40′ may simply be a hooked or curved end defined in a distal portion of guides 40, 40′ into which an outboard end of support rods 32, 32′ slot, or any other suitable retaining mechanism for preventing undesired retraction of flexible panels 24, 24′.

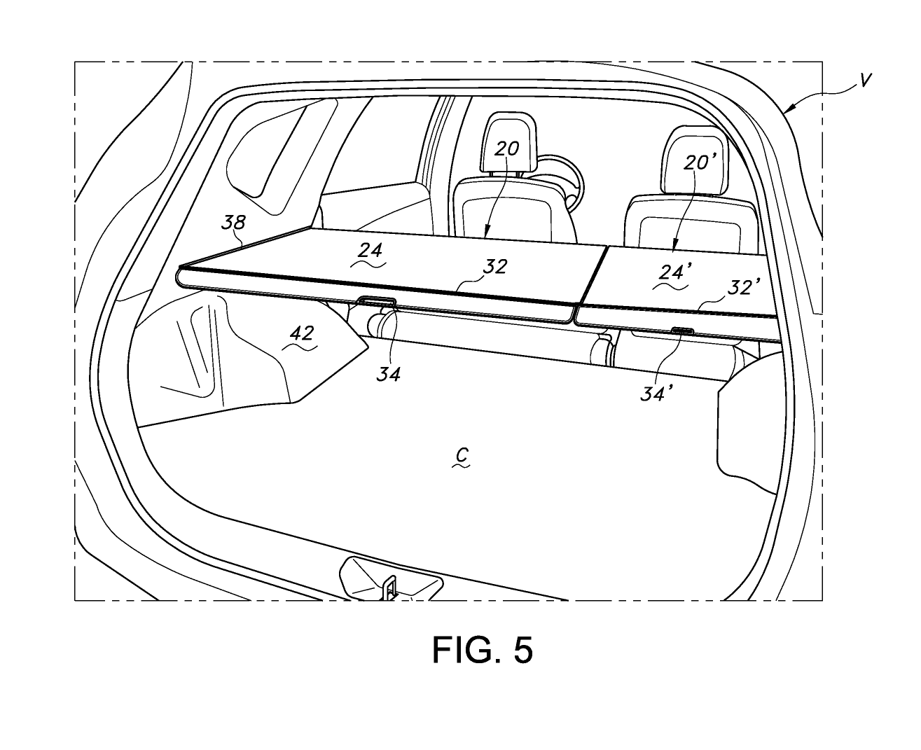

By the above-described features, yet another advantage of the presently disclosed cargo cover assemblies 20, 20′ is revealed. As shown in FIG. 5, even when the seatbacks 30, 30′ (not visible in this view) are fully folded forward, the cargo cover assemblies 20, 20′ may be deployed, and the outboard edges thereof received in and guided by guides 38 and held in place by receivers 40 (not visible in this view). Thus, even when seatbacks 30, 30′ are fully folded forward to maximize available storage space, one or both of the cargo cover assemblies 20, 20′ can be deployed to cover some or all of cargo area C.

Likewise, it will be appreciated that when one or both of the seatbacks 30, 30′ are reclined, the cargo cover assemblies 20, 20′ can still be deployed to cover some or all of cargo area C as desired. In contrast, a conventional roll type cargo cover cannot be used when only one seatback of a split seatback is reclined. Still further, as is known, in conventional cargo cover assemblies used with reclining seatbacks, it is necessary to position the cargo cover assembly to account for a reclined position of the seatback, leaving a gap between the cargo cover assembly and the seatback. This gap disadvantageously creates a section of the cargo area C that is uncovered, particularly when the seatback is in the fully upright position. By the above-described cargo cover assemblies 20, 20′ integrated into seatbacks 30, 30′, this problem is conveniently solved.

Obvious modifications and variations are possible in light of the above teachings. All such modifications and variations are within the scope of the appended claims when interpreted in accordance with the breadth to which they are fairly, legally and equitably entitled.

What is claimed:

1. A cargo cover assembly for a vehicle seat split seatback, comprising:
a plurality of retractors;
a flexible panel configured to deploy from and retract into each retractor;
at least one support rod associated with each flexible panel; and
a plurality of releasable fasteners for coupling adjacent aligned support rods to define a substantially transverse flexible panel support rib.

2. The assembly of claim 1, wherein each retractor comprises a rotary reel configured for deploying and retracting the flexible panel.

3. The assembly of claim 1, wherein the plurality of releasable fasteners are selected from the group consisting of magnetic fasteners, snap fit fasteners, friction fit fasteners, interference fit fasteners, latching fasteners, hook fasteners, and combinations.

4. A vehicle seat including the assembly of claim 1.

5. A vehicle including the seat assembly of claim 1.

6. A vehicle seat, comprising:
a bottom;
a back divided into portions;
a retractor disposed in an interior of each back portion;
a flexible panel configured to deploy from and retract into each retractor;
at least one support rod associated with each flexible panel; and
a plurality of releasable fasteners for coupling adjacent aligned support rods to define a substantially transverse flexible panel support rib.

7. The seat of claim 6, wherein each retractor is disposed in a substantially collinear orientation.

8. The seat of claim 6, wherein each retractor comprises a rotary reel configured for deploying and retracting the flexible panel.

9. The seat of claim 6, wherein the plurality of releasable fasteners are selected from the group consisting of magnetic fasteners, snap fit fasteners, friction fit fasteners, interference fit fasteners, latching fasteners, hook fasteners, and combinations.

10. A vehicle including the seat of claim 6.

11. A motor vehicle, comprising:
a cargo area;
a seat disposed at an end of the cargo area and having a back divided into portions;
a retractor disposed in an interior of each back portion;
a retractable flexible panel configured to deploy from each retractor to at least partially cover the cargo area;
at least one support rod associated with each flexible panel; and
a plurality of releasable fasteners for coupling adjacent aligned support rods to define a substantially transverse flexible panel support rib.

12. The vehicle of claim 11, wherein each retractor is disposed in a substantially collinear orientation.

13. The vehicle of claim 11, wherein each retractor comprises a rotary reel configured for deploying and retracting the flexible panel.

14. The vehicle of claim 11, wherein the plurality of releasable fasteners are selected from the group consisting of magnetic fasteners, snap fit fasteners, friction fit fasteners, interference fit fasteners, latching fasteners, hook fasteners, and combinations.

15. The vehicle of claim 11, further including a pair of guides each configured for receiving and guiding an outer edge of one of the flexible panels.

16. The vehicle of claim 15, wherein the pair of guides are each defined in a wall of a cargo area of the vehicle.

17. The vehicle of claim 11, further including at least one retainer for holding each flexible panel in a deployed configuration.

18. The vehicle of claim 16, wherein the at least one retainer is disposed at a distal end of each of the pair of guide slots.
